(19) United States
(12) Patent Application Publication
(10) Pub. No.: US 2006/0103313 A1
(43) Pub. Date: May 18, 2006

(54) Flat fluorescent lamp and liquid crystal display device having the same

(76) Inventors: Hae-Il Park, Seoul (KR); Jin-Seob Byun, Seoul (KR); Joong-Hyun Kim, Yongin-si (KR); Sang-Yu Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/210,544

(22) Filed: Aug. 24, 2005

(30) Foreign Application Priority Data
Nov. 16, 2004 (KR) 2004-93676

(51) Int. Cl. H01J 65/00; H01J 61/06; H01J 11/00

(52) U.S. Cl. 313/607

(57) ABSTRACT

A flat fluorescent lamp includes a first substrate, a second substrate combined with the first substrate to define a plurality of discharge spaces, and a first external electrode formed on the outer surface of the second substrate to cross the discharge spaces. A first region of the second substrate corresponding to an outermost discharge space has a thickness thinner than that of a second region of the second substrate corresponding to remaining discharge spaces not disposed outermost. Thus, the outermost discharge space may have a compensated luminance, thereby improving luminance uniformity of light emitted from the flat fluorescent lamp and display quality of the liquid crystal display device including the flat fluorescent lamp.

This application claims priority to Korean Patent Application No. 2004-93676, filed on Nov. 16, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a flat fluorescent lamp and a liquid crystal display device having the flat fluorescent lamp. More particularly, the present invention relates to a flat fluorescent lamp that emits light for displaying an image and a liquid crystal display device having the flat fluorescent lamp.

2. Description of the Related Art

Generally, a liquid crystal display (“LCD”) device is a type of flat panel display devices that displays an image using liquid crystal. The LCD device has many advantages such as thin thickness, lightweight structure, low driving voltage and low power consumption, and therefore the LCD device has been used in various industrial fields.

The LCD device includes an LCD panel displaying an image. The LCD panel is incapable of generating light, so the LCD device further includes a light source providing the LCD panel with light.

A cold cathode fluorescent lamp (“CCFL”) having a thin and long cylindrical shape has been widely used as a conventional light source. However, a quantity of such CCFLs employed in the LCD device increases as a size of the LCD device increases. Thus, manufacturing cost of the LCD device increases, and optical characteristics of the LCD device such as luminance uniformity lowers.

A flat fluorescent lamp has been developed in order to overcome the above-mentioned problems. The flat fluorescent lamp provides light in a surface shape. The flat fluorescent lamp includes a lamp body having an internal space divided into a plurality of discharge spaces and an electrode for applying a discharge voltage to the lamp body. In each discharge space of the flat fluorescent lamp, plasma discharge is generated by the discharge voltage applied to the electrode from an inverter. Ultraviolet (“UV”) light generated by the plasma discharge excites a fluorescent layer formed in the lamp body to generate visible light.

However, an outermost discharge space has a luminance inferior to that of remaining discharge spaces when the flat fluorescent lamp is operated. When a backlight assembly is manufactured by combining a surface light source device including the flat fluorescent lamp with a receiving container and other parts, the nonuniform luminance of the LCD device is increased, and thus luminance uniformity and display quality of the LCD device are reduced.

### BRIEF SUMMARY OF THE INVENTION

The present invention overcomes the above problems by providing a flat fluorescent lamp capable of improving luminance uniformity of light emitted therefrom to enhance display quality of a display device having the flat fluorescent lamp.

The present invention also provides a liquid crystal display (“LCD”) device having the above-mentioned flat fluorescent lamp.

In one exemplary embodiment of the present invention, a flat fluorescent lamp includes a first substrate, a second substrate, and a first external electrode. The second substrate is combined with the first substrate to define a plurality of discharge spaces. A first region of the second substrate corresponding to an outermost discharge space has a thickness thinner than that of a second region of the second substrate corresponding to the remaining discharge spaces not disposed outermost. The first external electrode is formed on an outer surface of the second substrate to cross the discharge spaces. The first region and the second region correspond to the first external electrode.

The flat fluorescent lamp further includes a second external electrode formed on an outer surface of the first substrate. The second external electrode corresponds to the first external electrode. A third region of the first substrate corresponding to the first region of the second substrate has a thickness thinner than that of a fourth region of the first substrate corresponding to the second region of the second substrate. The third region and the fourth region correspond to the second external electrode.

In another exemplary embodiment of the present invention, an LCD device includes a flat fluorescent lamp, an inverter, and an LCD panel. The flat fluorescent lamp includes a first substrate, a second substrate combined with the first substrate to define a plurality of discharge spaces, and a first external electrode formed on the outer surface of the second substrate to cross the discharge spaces. A first region of the second substrate corresponding to an outermost discharge space has a thickness thinner than that of a second region of the second substrate corresponding to the remaining discharge spaces not disposed outermost. The inverter outputs a discharge voltage to drive the flat fluorescent lamp. The LCD panel displays an image using light emitted from the flat fluorescent lamp.

In another aspect of the present invention, a flat fluorescent lamp includes a first substrate, a second substrate having a first side, a second side, a third side, and a fourth side, the second substrate combined with the first substrate to define a plurality of discharge spaces extending generally parallel with the third side and the fourth side, a first external electrode formed on an outer surface of the second substrate to cross the discharge spaces, and the first external electrode extending generally parallel to the first side of the second substrate. A region of the second substrate is located between the first external electrode and the discharge spaces having a varying thickness.

According to the above, the outermost discharge space may have a compensated luminance, thereby improving luminance uniformity of light emitted from the flat fluorescent lamp and display quality of the LCD device including the flat fluorescent lamp.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is an exploded perspective view illustrating an exemplary embodiment of a flat fluorescent lamp according to the present invention;

FIG. 2 is a cross sectional view taken along line I-I′ in FIG. 1;

FIG. 3 is a cross sectional view taken along line II-II′ in FIG. 1;

FIG. 4 is a plan view illustrating an exemplary second substrate and exemplary partition walls combined therewith in FIG. 1;

FIG. 5 is a cross sectional view illustrating another exemplary embodiment of a flat fluorescent lamp according to the present invention;

FIG. 6 is an exploded perspective view illustrating still another exemplary embodiment of a flat fluorescent lamp according to the present invention;

FIG. 7 is a cross sectional view taken along line III-III′ in FIG. 6;

FIG. 8 is an exploded perspective view illustrating still another exemplary embodiment of a flat fluorescent lamp according to the present invention;

FIG. 9 is a cross sectional view taken along line IV-IV′ in FIG. 8;

FIG. 10 is a cross sectional view taken along line V-V′ in FIG. 8;

FIG. 11 is an exploded perspective view illustrating an exemplary embodiment of a liquid crystal display device according to the present invention; and

FIG. 12 is a cross sectional view illustrating a liquid crystal display device in FIG. 11.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout. In the drawings, the thickness of layers, films, and regions are exaggerated for clarity.

It will be understood that when an element such as a layer, film region, or substrate is referred to as being “on” another element, it can be directly on the other element or intervening elements may also be present.

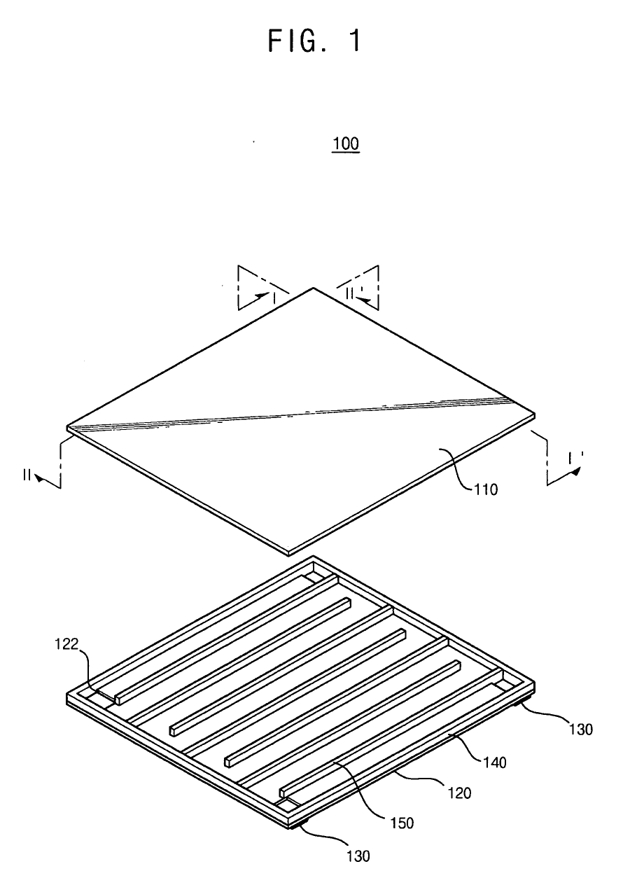

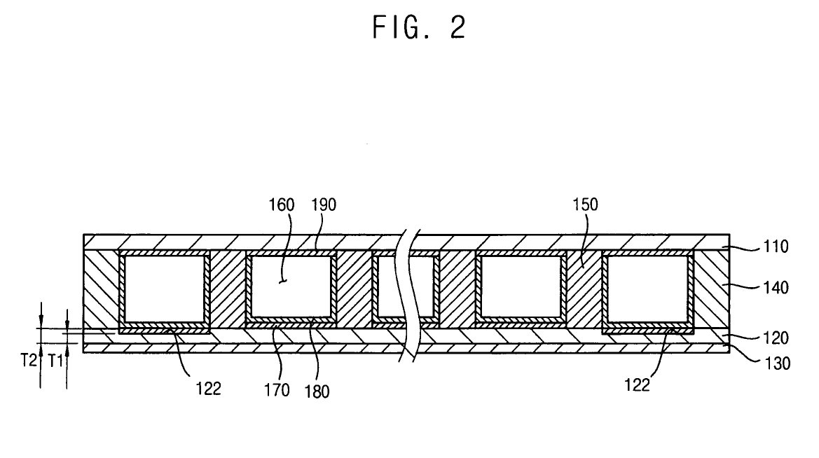

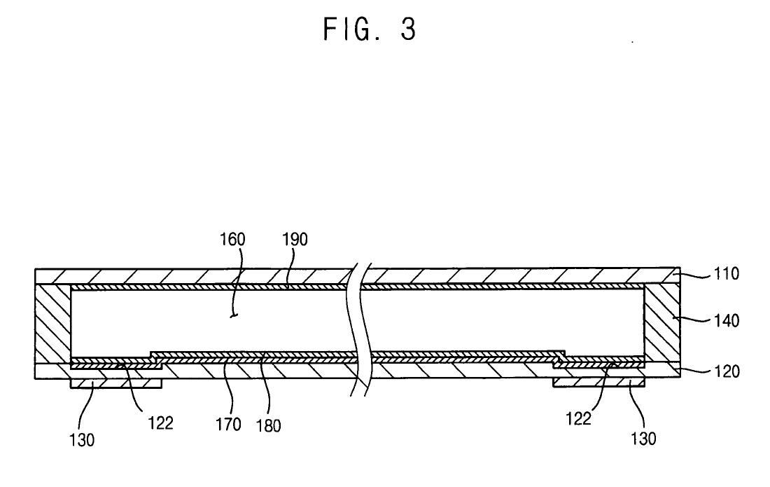

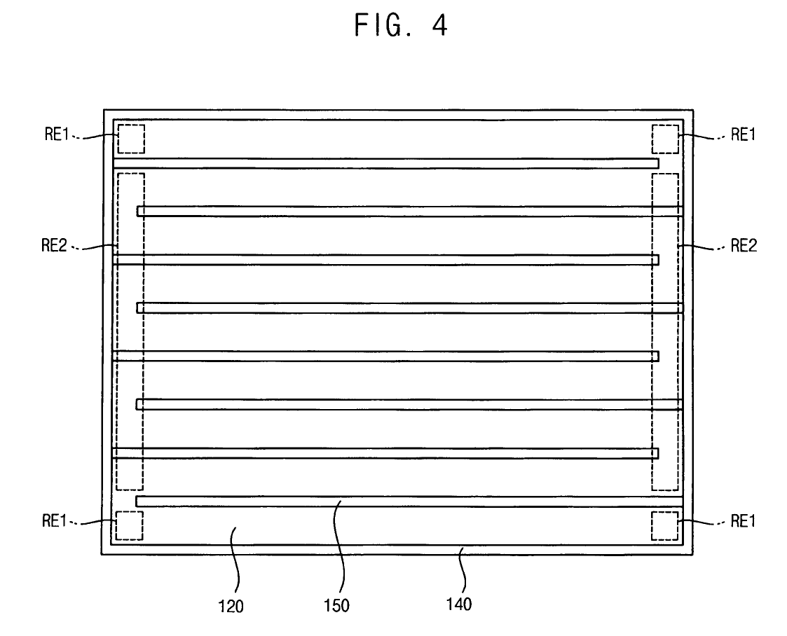

FIG. 1 is an exploded perspective view illustrating an exemplary embodiment of a flat fluorescent lamp according to the present invention. FIG. 2 is a cross sectional view taken along line I-I′ in FIG. 1. FIG. 3 is a cross sectional view taken along line II-II′ in FIG. 1. FIG. 4 is a plan view illustrating an exemplary second substrate and exemplary partition walls combined therewith in FIG. 1.

Referring to FIGS. 1 to 4, a flat fluorescent lamp 100 includes a first substrate 110, a second substrate 120, and a first external electrode 130.

The first substrate 110 having a rectangular plate shape may include transparent material to transmit visible light. The first substrate 110, for example, includes transparent glass. While a rectangular plate shape is described and illustrated as the shape of the first substrate 110, other shapes for the first substrate 100 would be within the scope of these embodiments. The first substrate 110 may include ultra-violet (“UV”) light shielding material so that UV light generated from an internal space of the flat fluorescent lamp 100 may not leak out.

The second substrate 120 is combined with the first substrate 110 to define a plurality of discharge spaces 160. The second substrate 120 has a rectangular plate shape, or other complimentary shape, substantially identical to the shape of the first substrate 110. The second substrate 120, for example, includes glass. The second substrate 120 may also include the UV light shielding material similar or substantially the same as the UV light shielding material included on the first substrate 110.

The second substrate 120 includes an inner surface facing the discharge spaces 160 and an oppositely facing outer surface. The first external electrode 130 is disposed on the outer surface of the second substrate 120 to cross all the discharge spaces 160. The first external electrode 130 corresponds to both longitudinal directional end portions of the partition wall 150. That is, one first external electrode is positioned on a first end portion of the second substrate 120 and another first external electrode 130 is positioned on a second end portion of the second substrate 120. The first end portion of the second substrate 120 may be adjacent a first side of the second substrate 120 and the second end portion of the second substrate 120 may be adjacent a second side of the second substrate 120. The first and second sides of the second substrate 120 may be parallel to each other, and may be connected to each other by third and fourth sides of the second substrate 120, thus defining the exemplary rectangular plate shape. The partition walls 150 may extend generally parallel to the third and fourth sides of the second substrate 120, and generally perpendicular to the first and second sides of the second substrate 120. The pair of first external electrodes 130 may be parallel to each other, and may each be perpendicular to a longitudinal direction of the discharge spaces 160. The first external electrode 130 is extended in a direction substantially perpendicular to a longitudinal direction of the partition wall 150 to overlap with all the discharge spaces 160. The first external electrode 130 has a substantially constant width along a longitudinal direction thereof. The first external electrode 130, for example, is formed by coating silver paste on the outer surface of the second substrate 120. The silver paste includes a mixture of silver (Ag) and silicon oxide (SiO₂). Alternatively, the first external electrode 130 may be formed by using a method of spray coating using a metal powder. The metal powder includes at least one of metallic materials such as copper (Cu), nickel (Ni), silver (Ag), gold (Au), aluminum (Al), chromium (Cr), etc. An insulation layer (not shown) may be disposed on an outer surface of the first external electrode 130 to protect the first external electrode 130.

The flat fluorescent lamp 100 further includes a sealing member 140 sealing a peripheral portion between the first and second substrates 110 and 120 to define an internal space and at least one partition wall 150 disposed between the first and second substrates 110 and 120 to divide the internal space into the discharge spaces 160.

The sealing member 140, for example, includes glass substantially identical to the first and second substrates 110 and 120. The sealing member 140 is combined with the first and second substrates 110 and 120 by an adhesive such as frit having a melting point lower than glass. The frit is a mixture of glass and metal. The sealing member 140 may extend around an entire periphery of the first and second substrates 110, 120, such as by extending adjacent the first, second, third, and fourth sides of the second substrate 120.

The partition walls 150 have a rod shape and are extended in a same direction as each other. The partition walls 150 are parallelly spaced at substantially same intervals so as to be equidistant from each other. Similar to the sealing member 140, the partition walls 150 may include glass. The partition walls 150 are combined with the first and second substrates 110 and 120 by an adhesive such as frit. Alternatively, the partition walls 150 may be formed using a dispenser. At least one of the first and second longitudinal directional end portions of the partition wall 150 is spaced apart from the sealing member 140 extending adjacent the first and second sides of the second substrate 120 so that a discharge gas injected into the internal space may be uniformly distributed in the discharge spaces 160. For example, the partition walls 150 are disposed in a serpentine shape. That is, a first end portion of odd numbered partition walls 150 is spaced apart from the sealing member 140 adjacent the first side of the second substrate 120, and a second end portion of even numbered partition walls 150 is spaced apart from the sealing member 140 adjacent the second side of the second substrate 120. Alternatively, the partition walls 150 may include an opening somewhere between the first and second end portions through which the discharge gas may flow when both end portions of the partition walls 150 make contact with the sealing member 140.

As shown in FIG. 4, the second substrate 120 includes a first region RE1 and a second region RE2. The first region RE1 corresponds to the outermost discharge spaces 160 and the second regions RE2 correspond to the remaining discharge spaces 160, that is, the discharge spaces excluding the outermost discharge spaces 160. The first and second regions RE1 and RE2 correspond to the first external electrode 130. That is, the first and second regions RE1 and RE2 of the second substrate 120 correspond to areas adjacent the first and second sides of the second substrate 120. In particular, first regions RE1 may include regions RE1 in corners of the second substrate 120 adjacent the first and third sides, the first and fourth sides, the second and third sides, and the second and fourth sides. The second regions RE2 may include regions RE2 between the first regions RE1 and adjacent the first side and the second side of the second substrate 120. Referring to FIG. 2, a first thickness T1 of the first region RE1 is thinner than a second thickness T2 of the second region RE2 to prevent luminance of the outermost discharge spaces 160 from being lowered. By outermost discharge spaces 160, it should be understood that these discharge spaces 160 are located closest to third and fourth sides of the second substrate 120. In particular, the luminance of the light emitted from the flat fluorescent lamp 100 is closely related to a capacitive impedance of an electrode part. The luminance is proportional to a current in the discharge space 160. The current in the discharge space 160 is proportional to a capacitance formed between the first external electrode 130 and the discharge space 160 by media of the second substrate 120. The capacitance has an inversely proportional relationship to a thickness of the second substrate 120. Thus, as the thickness of the second substrate 120 becomes thinner, the capacitance between the first external electrode 130 and the discharge space 160 increases, and thus the current in the discharge space 160 increases. Therefore, the overall luminance of the light emitted from the flat fluorescent lamp 100 increases. In one embodiment, the thickness of the second substrate 120 corresponding to the outermost discharge space 160 is formed relatively thin in at least the area corresponding to the first region RE1. Without the decreased thickness of the second substrate 120 in the first region RE1, the outermost discharge space 160 has a low luminance. Thus, the luminance thereof may be compensated. A first groove 122 is formed on the first region RE1 from the inner surface of the second substrate 120 toward the outer surface of the second substrate 120. That is, the inner surface of the second substrate 120 is recessed in the first regions RE1. Since the first groove 122 is formed on the first region RE1, a first thickness T1 of the first region RE1 is thinner than a second thickness T2 of the second region RE2. The first thickness T1 may vary according to a luminance difference between the discharge spaces 160. For example, the second thickness T2 of the second region RE2 may be about 1.1 mm, and the first thickness T1 of the first region RE1 may be about 0.7 mm.

With reference to FIGS. 2 and 3, the flat fluorescent lamp 100 further includes a reflective layer 170 formed on the inner surface of the second substrate 120, a first fluorescent layer 180 formed on an upper surface of the reflective layer 170 facing the discharge spaces 160, and a second fluorescent layer 190 formed on an inner surface of the first substrate 110 facing the discharge spaces 160.

The reflective layer 170 reflects visible light generated from the first and second fluorescent layers 180 and 190, and thus prevents the visible light from leaking through the second substrate 120. The reflective layer 170 may include metal oxide to increase reflectivity thereof and to reduce change of color coordinate. For example, the reflective layer 170 may include aluminum oxide (Al₂O₃) and/or barium sulfate (BaSO₄).

The first fluorescent layer 180 and second fluorescent layer 190 transform UV light generated by plasma discharge into visible light. As shown in FIG. 2, the first fluorescent layer 180 may be formed on lateral faces of the partition walls 150. In one exemplary embodiment for manufacturing the flat fluorescent lamp 100, the reflective layer 170, the first fluorescent layer 180, and the second fluorescent layer 190 may be sprayed onto the first substrate 110 and the second substrate 120 to form a thin film before the first and second substrates 110 and 120 are combined with each other. In another exemplary embodiment for manufacturing the flat fluorescent lamp 100, the reflective layer 170, the first fluorescent layer 180, and the second fluorescent layer 190 are not formed on a region corresponding to the partition walls 150.

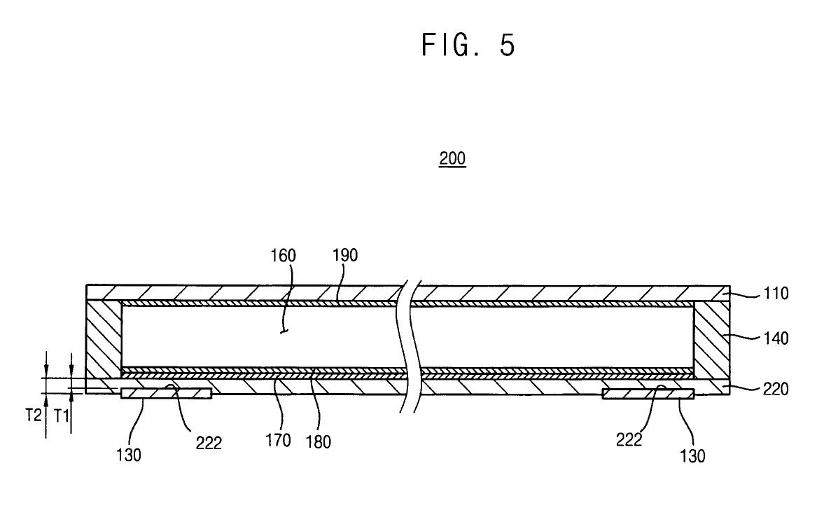

FIG. 5 is a cross sectional view illustrating another exemplary embodiment of a flat fluorescent lamp according to the present invention. The flat fluorescent lamp of FIG. 5 is substantially identical to the flat fluorescent lamp shown in FIGS. 1 to 4 except for a second substrate. Thus, any further description for the substantially same elements will be omitted.

Referring to FIG. 5, a flat fluorescent lamp 200 includes a first substrate 110, a second substrate 220 combined with the first substrate 110 to define a plurality of discharge spaces 160, and a first external electrode 130 formed on an outer surface of the second substrate 220 to cross the discharge spaces 160.

As in the prior embodiment illustrated in FIG. 4, the second substrate 220 includes a first region RE1 and a second region RE2. The first region RE1 corresponds to the outermost discharge spaces 160 and the second region RE2 corresponds to the remaining discharge spaces 160, that is, the discharge spaces 160 excluding the outermost discharge spaces 160. The first and second regions RE1 and RE2 correspond to the first external electrode 130, by extending adjacent the first and second sides of the second substrate 120. A first thickness T1 of the first region RE1 is thinner than a second thickness T2 of the second region RE2 to prevent luminance of the outermost discharge spaces 160 from being lowered. In order to form the first thickness T1 thinner than the second thickness T2, a second groove 222 is formed on the first region RE1 from an outer surface of the second substrate 220 toward an inner surface of the second substrate 220. That is, the outer surface of the second substrate 220 is formed with recesses in the first regions RE1. Since the second groove 222 is formed in the first region RE1, a first thickness T1 of the first region RE1 is thinner than a second thickness T2 of the second region RE2. The first thickness T1 may vary according to a luminance difference between the discharge spaces 160. For example, the second thickness T2 of the second region RE2 may be about 1.1 mm, and the first thickness T1 of the first region RE1 may be about 0.7 mm.

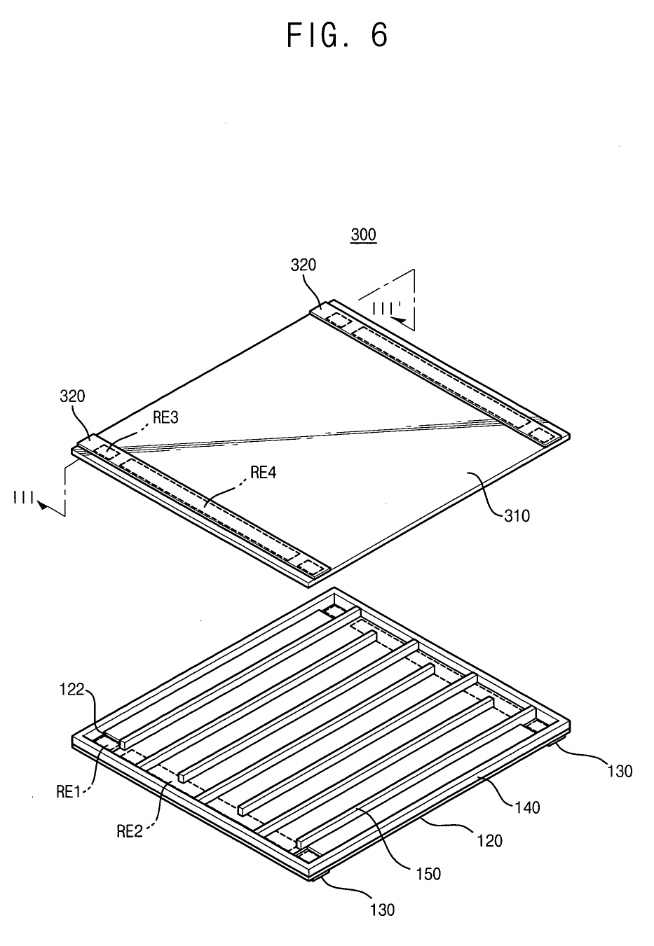

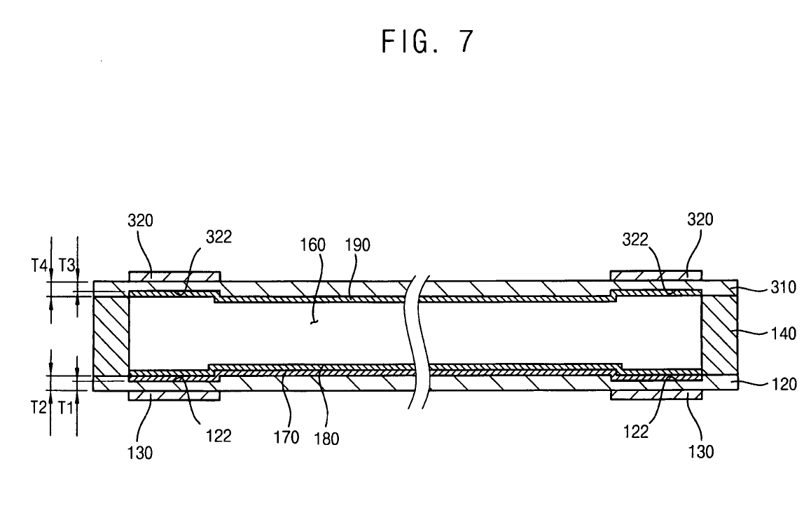

FIG. 6 is an exploded perspective view illustrating still another exemplary embodiment of a flat fluorescent lamp according to the present invention. FIG. 7 is a cross sectional view taken along line III-III′ in FIG. 6. The flat fluorescent lamp of FIGS. 6 and 7 is substantially identical to the flat fluorescent lamp 100 shown in FIGS. 1 to 4 except for a first substrate and a second external electrode. Thus, any further description for the substantially same elements will be omitted.

Referring to FIGS. 6 and 7, a flat fluorescent lamp 300 includes a first substrate 310, a second substrate 120 combined with the first substrate 310 to define discharge spaces 160, a first external electrode 130 formed on an outer surface of the second substrate 120 and a second external electrode 320 formed on an outer surface of the first substrate 310, where the first substrate 310 includes an inner surface facing the discharge spaces 160 and an outer surface facing away from the discharge spaces 160. The first substrate 310 may also include a first side and a second side, corresponding, respectively, to the first and second sides of the second substrate 120. The second external electrodes 320 extend adjacent the first and second sides of the first substrate 310. The first substrate 310 also includes third and fourth sides, corresponding to third and fourth sides of the second substrate 120, respectively.

The second external electrode 320 corresponds to the first external electrode 130. For example, the second external electrode 320 may be formed on the first substrate 310 using substantially a same material and by a substantially same method as that used for forming the first external electrode 130.

The first substrate 310 includes a third region RE3 corresponding to the first region RE1 of the second substrate 120 and a fourth region RE4 corresponding to the second region RE2 of the second substrate 120. That is, a line passing perpendicularly through the first region RE1 of the second substrate 120 would also pass through the third region RE3 of the first substrate 310, and a line passing perpendicularly through the second region RE2 of the second substrate 120 also passes through the fourth region RE4 of the first substrate 310. The third region RE3 and the fourth region RE4 correspond to the second external electrode 320. That is, the third and fourth regions RE3 and RE4 of the first substrate 310 correspond to areas adjacent the first and second sides of the first substrate 310. In particular, third regions RE3 may include regions RE3 in corners of the first substrate 310 adjacent the first and third sides, the first and fourth sides, the second and third sides, and the second and fourth sides of the first substrate 310. The fourth regions RE4 may include regions RE4 between the third regions RE3 and adjacent the first side and the second side of the first substrate 310.

In order to further compensate for the lowered luminance of the outermost discharge spaces 160, a third thickness T3 of the third region RE3 is thinner than a fourth thickness T4 of the fourth region RE4. In order to form the third thickness T3 thinner than the fourth thickness T4, a third groove 322 is formed on the third region RE3 from the inner surface of the first substrate 310 toward the outer surface of the first substrate 310. That is, the inner surface of the first substrate 310 is recessed in third regions RE3. The third thickness T3 may vary according to a luminance difference between the discharge spaces 160. For example, the fourth thickness T4 of the fourth region RE4 may be about 1.1 mm, and the third thickness T3 of the third region RE3 may be about 0.7 mm. Alternatively, a groove may be formed on the third region RE3 from the outer surface of the first substrate 310 toward the inner surface of the first substrate 310, as illustrated in FIG. 5 with the second groove 222. That is, the outer surface of the first substrate 310 may be recessed in third regions RE3.

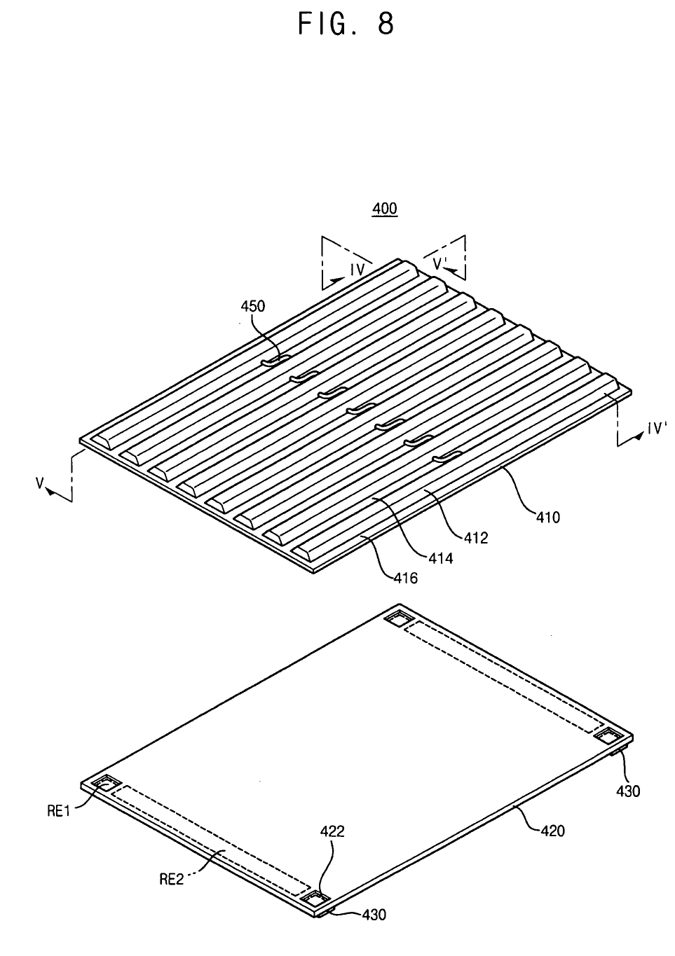

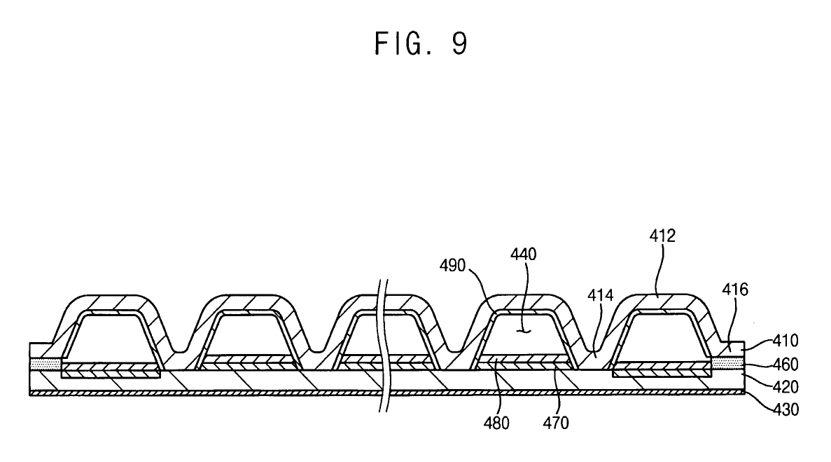

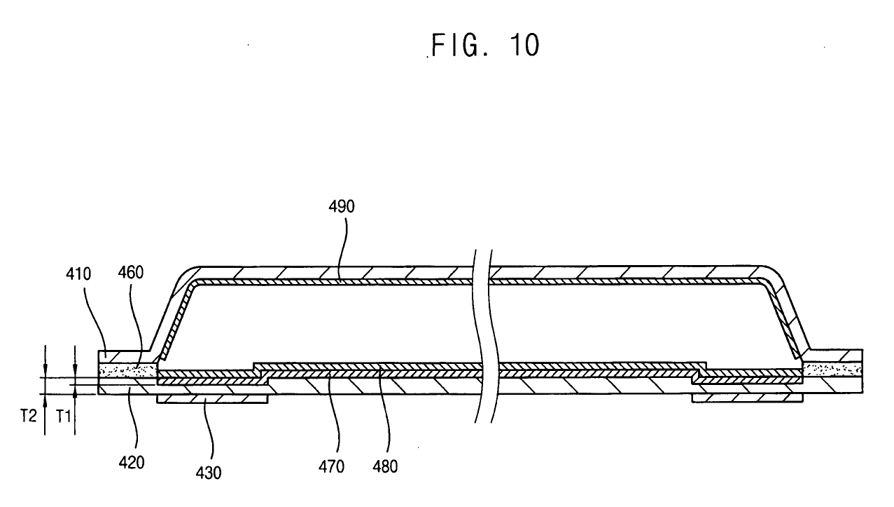

FIG. 8 is an exploded perspective view illustrating still another exemplary embodiment of a flat fluorescent lamp according to the present invention. FIG. 9 is a cross sectional view taken along line IV-IV′ in FIG. 8. FIG. 10 is a cross sectional view taken along line V-V′ in FIG. 8.

Referring to FIGS. 8 to 10, a flat fluorescent lamp 400 includes a first substrate 410, a second substrate 420 combined with the first substrate 410 to define discharge spaces 440, and a first external electrode 430 formed on an outer surface of the second substrate 420 to cross the discharge spaces 440.

In one exemplary embodiment, one first external electrode 430 is positioned on a first end portion of the second substrate 420 and another first external electrode 430 is positioned on a second end portion of the second substrate 420. The first end portion of the second substrate 420 may be adjacent a first side of the second substrate 420 and the second end portion of the second substrate 420 may be adjacent a second side of the second substrate 420. The first and second sides of the second substrate 420 may be parallel to each other, and may be connected to each other by third and fourth sides of the second substrate 420, thus defining an exemplary rectangular plate shape. The pair of first external electrodes 430 may be parallel to each other, and may each be perpendicular to a longitudinal direction of the discharge spaces 440.

The first substrate 410 includes discharge space portions 412, space dividing portions 414, and a sealing portion 416. The discharge space portions 412 are spaced apart from the second substrate 420 to define the discharge spaces 440. The space dividing portions 414 are formed between the discharge space portions 412, and make contact with the second substrate 420 when the first and second substrates 410 and 420 are combined with each other. The space dividing portions 414 may extend generally parallel to the third and fourth sides of the second substrate 420, and generally perpendicular to the first and second sides of the second substrate 420. The sealing portion 416 corresponds to an edge portion of the first substrate 410, such as along a periphery of the first substrate 410. The first and second substrates 410 and 420 are combined with each other at the sealing portion 416. The first substrate 410 includes a transparent material to transmit visible light generated from the discharge spaces 440. The first substrate 410, for example, includes glass.

The first substrate 410 may be formed, for example, through a forming process. In particular, a flat base substrate may be heated and processed by a mold to form the first substrate 410 having the discharge space portions 412, the space dividing portions 414, and the sealing portion 416. Alternatively, the first substrate 410 may be formed by blowing air into the heated base substrate or by other various methods. By integrally forming the space dividing portions 414 with the discharge space portions 412, the need for separately manufacturing partition walls 150, as employed in the prior embodiments, is eliminated.

A cross-section of the first substrate 410 has, for example, a plurality of arch shapes aligned in a series as shown in FIG. 9. Alternatively, the cross-section of the first substrate 410 may have a plurality of semicircular shapes, a plurality of rectangular shapes, a plurality of trapezoidal shapes, etc.

The flat fluorescent lamp 400 includes at least one connection passage 450 connecting adjacent discharge spaces 440 to each other. While only one connection passage 450 is illustrated between adjacent discharge spaces 440, any number of connection passages 450 may be provided between adjacent discharge spaces 440. The connection passage 450 is formed on the space dividing portions 414. The connection passage 450 provides a passage through which air and discharge gas may flow. When the air in the discharge spaces 440 is exhausted and the discharge gas is injected into the discharge spaces 440, the air and the discharge gas may flow therethrough, respectively. The connection passage 450 may be simultaneously formed when the forming process of the first substrate 410 is performed. The connection passage 450 may have various shapes connecting the adjacent discharge spaces 440 to each other. The connection passage 450, for example, has an S-shape along a longitudinal direction of the space dividing portions 414. While the illustrated connection passages 450 are shown located at the same distance between the first and second sides of the first substrate 410, it should further be understood that each connection passage 450 may be located at any longitudinal location with respect to its adjacent discharge spaces, and that the locations with regards to a distance between the first and second sides of the first substrate 410 may vary from one connection passage 450 to the next.

The first and second substrates 410 and 420 are combined with each other, for example, through a sealing member 460 such as frit. The frit is a mixture of glass and metal, and has a melting point lower than glass. The sealing member 460 is disposed between the inner surface of the second substrate 420 and an inner surface of the sealing portion 416 of the first substrate 410, and then the sealing member 460 is heated to combine the first and second substrates 410 and 420 with each other. Here, the sealing member 460 is formed only on the sealing portion 416 of the first substrate 410, and is not formed on the space dividing portions 414 making contact with the second substrate 420. The space dividing portions 414 are compressed toward the second substrate 420 to make contact with the second substrate 420 due to a pressure difference between an interior and an exterior of the flat fluorescent lamp 400. In particular, when the first and second substrates 410 and 420 are combined with each other during manufacture, air disposed in the discharge spaces 440 is exhausted, and then discharge gas is injected into the discharge spaces 440. Examples of the discharge gas include mercury (Hg), neon (Ne), argon (Ar), xenon (Xe), krypton (Kr), etc., such that a pressure of the discharge spaces 440 becomes between about 50 Torr to about 70 Torr. Atmospheric pressure is about 760 Torr and is therefore much greater than the pressure of the discharge spaces 440. Thus, a force from the exterior toward the interior of the flat fluorescent lamp 400 is generated by the above-described pressure difference between the interior and the exterior of the flat fluorescent lamp 400, thereby compressing the space dividing sections 414 of the first substrate 410 toward the second substrate 420.

The second substrate 420 includes a first region RE1 and a second region RE2. The first regions RE1 correspond to the outermost discharge spaces 440 and the second regions RE2 correspond to the remaining discharge spaces 440, that is, the discharge spaces 440 excluding the outermost discharge space 440. The first and second regions RE1 and RE2 correspond to the first external electrode 430. That is, the first and second regions RE1 and RE2 of the second substrate 420 correspond to areas adjacent the first and second sides of the second substrate 420. In particular, first regions RE1 may include regions RE1 in corners of the second substrate 420 adjacent the first and third sides, the first and fourth sides, the second and third sides, and the second and fourth sides. The second regions RE2 may include regions RE2 between the first regions RE1 and adjacent the first side and the second side of the second substrate 420. As shown in FIG. 10, a first thickness T1 of each of the first regions RE1 is thinner than a second thickness T2 of each of the second regions RE2 to prevent luminance of the outermost discharge spaces 160 from being lowered. In order to form the first thickness T1 thinner than the second thickness T2, a groove 422 is formed on each of the first regions RE1 from an inner surface of the second substrate 420 toward an outer surface of the second substrate 420, such that an inner surface of the second substrate 420 is recessed in areas corresponding to the first regions RE1. Alternatively, a groove may be formed on each of the first regions RE1 from the outer surface of the second substrate 420 toward the inner surface of the second substrate 420.

The first external electrode 430 is formed on the outer surface of the second substrate 420 to cross all the discharge spaces 440 by extending on the first and second end portions of the second substrate 420 adjacent the first and second sides, respectively, of the second substrate 420. In the present embodiment, the first external electrode 430 may be formed using a substantially identical material and by a substantially identical method to the first external electrode shown in FIG. 1. Thus, any further description therefore will be omitted. The flat fluorescent lamp 400 may further include a second external electrode formed on an outer surface of the first substrate 410, with the second external electrode corresponding to the first external electrode 430.

The flat fluorescent lamp 400 further includes a reflective layer 470, a first fluorescent layer 480, and a second fluorescent layer 490. The reflective layer 470 is formed on the inner surface of the second substrate 420. The first fluorescent layer 480 is formed on an upper surface of the reflective layer 470 facing the discharge space 440. The second fluorescent layer 490 is formed on an inner surface of the first substrate 410 facing the discharge space 440. The reflective layer 470 reflects visible light generated from the first fluorescent layer 480 and the second fluorescent layer 490 to prevent the visible light from leaking through the second substrate 420. The first fluorescent layer 480 and the second fluorescent layer 490 transform UV light generated by plasma discharge into visible light. The reflective layer 470, the first fluorescent layer 480, and the second fluorescent layer 490 are formed on a region corresponding to the discharge spaces 440 and therefore need not be formed on a region corresponding to the space dividing portions 414.

As described above, regions of a substrate overlying an external electrode and corresponding to both outermost discharge spaces have a thickness thinner than that of each remaining region of the substrate overlying an external electrode, thereby compensating for lowered luminance of the outermost discharge spaces. Alternatively, regions of a substrate corresponding to one or two discharge spaces adjacent to the outermost discharge spaces may also have a thickness thinner than that of each remaining region. In another example, the thickness of regions of a substrate corresponding to an external electrode may increase gradually from the outermost discharge spaces to a centralmost discharge space, such that a centralmost discharge space would have the greatest thickness, and the thickness within the regions overlying the external electrode would decrease gradually until it reaches the thinnest thickness within a region of the outermost discharge spaces. Alternatively, regardless of a position of discharge spaces, luminance of each discharge space may be controlled by controlling a thickness of each region of a substrate corresponding thereto.

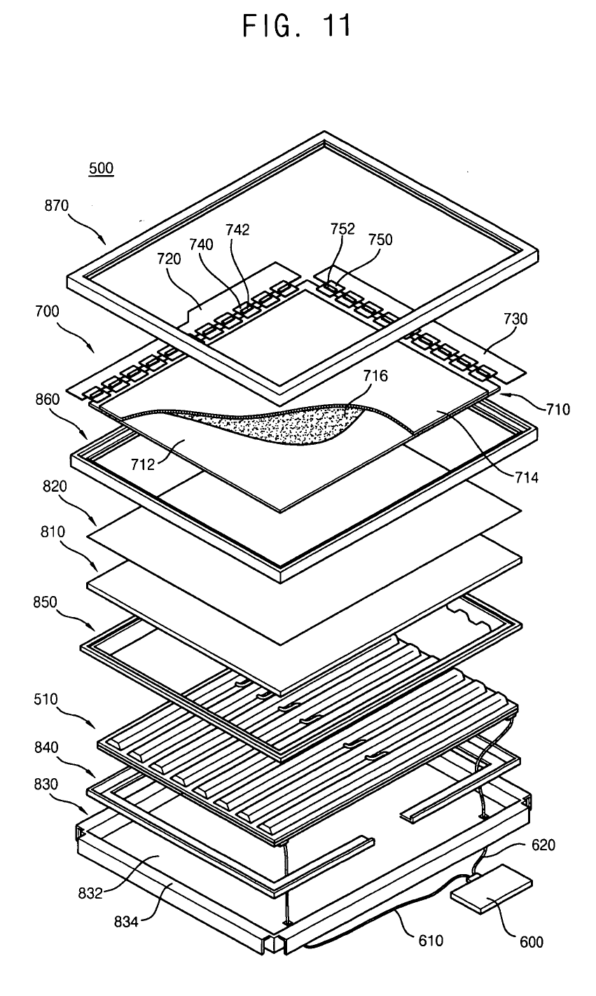

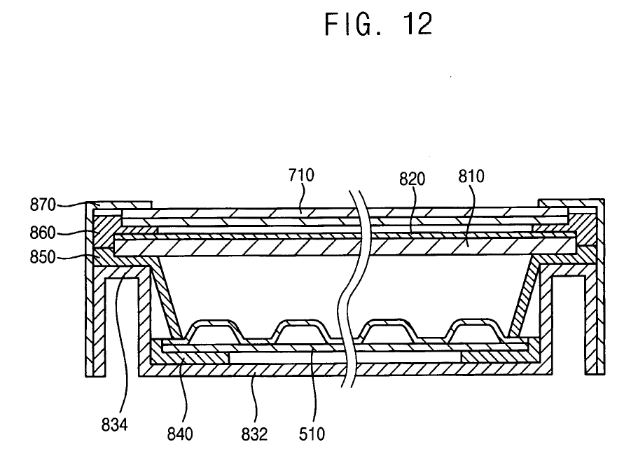

FIG. 11 is an exploded perspective view illustrating an exemplary embodiment of a liquid crystal display device according to the present invention. FIG. 12 is a cross sectional view illustrating a liquid crystal display device in FIG. 11.

Referring to FIGS. 11 and 12, an LCD device 500 includes a flat fluorescent lamp 510 generating light, an inverter 600 outputting a discharge voltage to drive the flat fluorescent lamp 510, and a display unit 700 displaying an image.

The inverter 600 generates the discharge voltage for driving the flat fluorescent lamp 510. The inverter 600 receives an external alternating voltage and generates the discharge voltage. The inverter 600 may be disposed on a rear surface of a receiving container 830. The discharge voltage is applied to external electrodes of the flat fluorescent lamp 510 through a first wire 610 and a second wire 620.

The display unit 700 includes an LCD panel 710, a data printed circuit board (“PCB”) 720 and a gate PCB 730. The LCD panel 710 displays an image using light provided from the flat fluorescent lamp 510. The data and gate PCBs 720 and 730 provide the LCD panel 710 with driving signals.

The driving signals provided from the data PCB 720 and the gate PCB 730 are applied to the LCD panel 710 through a data flexible printed circuit (“FPC”) 740 and a gate FPC 750. For example, a tape carrier package (“TCP”), a chip on film (“COF”), etc. may be employed as the data FPC 740 and the gate FPC 750. The data and gate FPCs 740 and 750 include a data driver chip 742 and a gate driver chip 752, respectively, in order to control timing for applying the driving signals provided from the data and gate PCBs 720 and 730.

The data PCB 720 may be disposed on a lateral face or a rear face of a receiving container 830 by bending the data FPC 740. The gate PCB 730 may be disposed on a lateral face or a rear face of the receiving container 830 by bending the gate FPC 750. Alternatively, the gate PCB 730 may be replaced with signal lines formed on the LCD panel 710 and/or the gate FPC 750.

The LCD panel 710 includes a first substrate 712, a second substrate 714 combined with the first substrate 712, and a liquid crystal layer 716 interposed between the first and second substrates 712 and 714.

Thin film transistors (“TFTs”) a reformed on the first substrate 712 in a matrix shape. The first substrate 712 includes, for example, glass. A data line is electrically connected to a source terminal of each TFT, and a gate line is electrically connected to a gate terminal of each TFT. A pixel electrode including a transparent conductive material is electrically connected to a drain terminal of each TFT.

RGB pixels are formed on the second substrate 714 in a thin film form. The second substrate 714 includes, for example, glass. A common electrode including a transparent conductive material is formed on the second substrate 714.

In the LCD panel 710 having the above-described structure, when a power is applied to the gate terminal of the TFT, and the TFT is turned on, electric fields are generated between the pixel electrode and the common electrode to rearrange molecules of the liquid crystal layer 716 between the first and second substrates 712 and 714. When an arrangement of the liquid crystal molecules is changed, optical transmissivity thereof is also changed to display an image having a desired gradation.

The LCD device 500 includes a light-diffusion plate 810 and an optical sheet 820. The light-diffusion plate 810 is disposed on or over the flat fluorescent lamp 510 so as to diffuse the light emitted from the flat fluorescent lamp 510. The optical sheet 820 is placed on or over the light-diffusion plate 810.

The light-diffusion plate 810 diffuses the light emitted from the flat fluorescent lamp 510 to improve luminance uniformity thereof. The light-diffusion plate 810 having a plate shape is spaced apart from the flat fluorescent lamp 510.

The light-diffusion plate 810, for example, includes poly methyl methacrylate (“PMMA”)

The optical sheet 820 changes a path of light diffused by the light-diffusion plate 810, thereby improving luminance characteristics. The optical sheet 820 may include a light-condensing sheet condensing the light diffused by the light-diffusion plate 810 in a front view direction, thereby improving front-view luminance. In addition, the optical sheet 820 may include an additional light-diffusing sheet for additionally diffusing the light diffused by the light-diffusion plate 810. That is, the optical sheet 820 may include only one or may include a plurality of sheets for adjusting the light transmitted to the LCD panel 710. Thus, the LCD device 500 may optionally include or exclude various optical sheets according to characteristics of desired luminance.

The LCD device 500 may further include a receiving container 830 receiving the flat fluorescent lamp 510. The receiving container 830 includes a bottom part 832 and a lateral part 834 extended from an edge portion of the bottom part 832 to define a receiving space. The lateral part 834, for example, has a cross-sectional U-shape to provide a space for combining with various elements and to enhance a combining force with the elements. The receiving container 830, for example, includes a metal having a high strength and a low deformation.

The LCD device 500 may further include an insulation member 840 disposed between the flat fluorescent lamp 510 and the receiving container 830 to support the flat fluorescent lamp 510. The insulation member 840 is correspondingly disposed relative to an edge portion of the flat fluorescent lamp 510 to space the flat fluorescent lamp 510 apart from the receiving container 830 by a predetermined interval, thereby preventing the flat fluorescent lamp 510 from being electrically connected to the receiving container 830. Thus, the insulation member 840 includes an electrically insulating material. In addition, the insulation member 840 may include an elastic material for absorbing an impact. For example, the insulation member 840 includes silicon. In the present embodiment, the insulation member 840 has two fragments, where each fragment has a U-shape. Alternatively, the insulation member 840 may include four fragments corresponding to four sides or four corners of the flat fluorescent lamp 510, respectively. Alternatively, the insulation member 840 may be integrally formed in a frame shape.

The LCD device 500 optionally includes a first mold frame 850 disposed between the flat fluorescent lamp 510 and the light-diffusion plate 810. The first mold frame 850 fastens an edge portion of the flat fluorescent lamp 510 to the receiving container 830 and supports the light-diffusion plate 810 thereon, thus spacing the light diffusion plate 810 from the flat fluorescent lamp 510 as shown in FIG. 12. The first mold frame 850 is coupled to the lateral part 834 of the receiving container 830. The first mold frame 850 is integrally formed in a frame structure as shown in FIG. 11. Alternatively, the first mold frame 850 may be formed in a fragmented structure, for example, including a U-shape fragment or an L-shape fragment.

The LCD device 500 optionally includes a second mold frame 860 disposed between the optical sheet 820 and the LCD panel 710. The second mold frame 860 fastens the optical sheet 820 and the light-diffusion plate 810 to the receiving container 830, and supports the LCD panel 710. Similar to the first mold frame 850, the second mold frame 860 may be either integrally formed in a frame structure or formed in a fragmented structure.

The LCD device 500 optionally includes a top chassis 870. The top chassis 870 surrounds an edge portion of the LCD panel 710 and is combined with the receiving container 830 to fasten the LCD panel 710 to an upper portion of the second mold frame 860. The top chassis 870 prevents the LCD panel 710 from being damaged and drifting from the second mold frame 860.

According to the present invention, a region of a substrate corresponding to an outermost discharge space has a thickness thinner than that of each remaining discharge space, that is the discharge spaces excluding the outermost discharge space, thereby compensating for lowered luminance of the outermost discharge space. Thus, luminance uniformity of light emitted from a flat fluorescent lamp and display quality of an LCD device including the flat fluorescent lamp may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A flat fluorescent lamp comprising:
a first substrate;
a second substrate combined with the first substrate to define a plurality of discharge spaces, a first region of the second substrate corresponding to an outermost discharge space having a thickness thinner than that of a second region of the second substrate corresponding to discharge spaces not disposed outermost; and
a first external electrode formed on an outer surface of the second substrate.

2. The flat fluorescent lamp of claim 1, wherein the first region and the second region correspond to the first external electrode.

3. The flat fluorescent lamp of claim 2, further comprising a pair of first external electrodes, one first external electrode disposed adjacent a first side of the second substrate, and another first external electrode disposed adjacent a second side of the second substrate.

4. The flat fluorescent lamp of claim 3, further comprising a third side and a fourth side of the second substrate, and further comprising a pair of outermost discharge spaces adjacent the third and fourth sides of the second substrate, the second substrate further comprising a plurality of first regions one of which is within each corner area of the second substrate.

5. The flat fluorescent lamp of claim 4, further comprising a pair of second regions, one second region located adjacent the first side of the second substrate and between a first pair of first regions, and another second region located adjacent the second side of the second substrate and between a second pair of first regions.

6. The flat fluorescent lamp of claim 2, wherein the first region of the second substrate is located between the first external electrode and the outermost discharge space.

7. The flat fluorescent lamp of claim 2, wherein the second substrate includes a first groove formed on an inner surface of the second substrate, the first groove corresponding to the first region.

8. The flat fluorescent lamp of claim 2, wherein the second substrate includes a first groove formed on the outer surface of the second substrate, the first groove corresponding to the first region.

9. The flat fluorescent lamp of claim 1, wherein the first external electrode has a substantially constant width along a longitudinal direction thereof.

10. The flat fluorescent lamp of claim 1, further comprising a second external electrode formed on an outer surface of the first substrate, the second external electrode corresponding to the first external electrode.

11. The flat fluorescent lamp of claim 10, wherein a third region of the first substrate corresponding to the first region of the second substrate has a thickness thinner than that of a fourth region of the first substrate corresponding to the second region of the second substrate.

12. The flat fluorescent lamp of claim 11, wherein the third region and the fourth region correspond to the second external electrode.

13. The flat fluorescent lamp of claim 12, further comprising a plurality of first regions one of which is within each corner area of the second substrate and a plurality of third regions one of which is within each corner of the first substrate.

14. The flat fluorescent lamp of claim 1, further comprising:
a sealing member sealing a peripheral portion between the first and second substrates to define an internal space; and
at least one partition wall disposed between the first and second substrates to divide the internal space into the discharge spaces.

15. The flat fluorescent lamp of claim 1, wherein the first substrate comprises:
discharge space portions spaced apart from the second substrate to define the discharge spaces;
space dividing portions disposed between the discharge space portions to make contact with the second substrate; and
a sealing portion formed on a peripheral portion of the first substrate, the first and second substrates being combined with each other through the sealing portion.

16. The flat fluorescent lamp of claim 1, further comprising:
a reflective layer disposed on an inner surface of the second substrate; and
a fluorescent layer disposed on the reflective layer and on an inner surface of the first substrate.

17. The flat fluorescent lamp of claim 1, wherein the second region of the second substrate has a thickness gradually increasing from a location corresponding to a discharge space adjacent the outermost discharge space to a location corresponding to a centralmost discharge space.

18. The flat fluorescent lamp of claim 1, wherein the first external electrode is formed on the outer surface of the second substrate to cross the discharge spaces.

19. A liquid crystal display device comprising:
a flat fluorescent lamp comprising:
a first substrate;
a second substrate combined with the first substrate to define a plurality of discharge spaces, a first region of the second substrate corresponding to an outermost discharge space having a thickness thinner than that of a second region of the second substrate corresponding to discharge spaces not disposed outermost; and
a first external electrode formed on an outer surface of the second substrate;
an inverter outputting a discharge voltage to drive the flat fluorescent lamp; and
a liquid crystal display panel configured to display an image using light emitted from the flat fluorescent lamp.

20. The liquid crystal display device of claim 19, further comprising a plurality of first regions one of which is within each corner area of the second substrate.

21. The liquid crystal display device of claim 19, wherein the first region and the second region correspond to the first external electrode.

22. The liquid crystal display device of claim 21, wherein the first external electrode has a substantially constant width along a longitudinal direction thereof.

23. The liquid crystal display device of claim 19, further comprising a second external electrode formed on an outer surface of the first substrate, the second external electrode corresponding to the first external electrode.

24. The liquid crystal display device of claim 23, wherein a third region of the first substrate corresponding to the first region of the second substrate has a thickness thinner than that of a fourth region of the first substrate corresponding to the second region of the second substrate.

25. The liquid crystal display device of claim 24, wherein the third region and the fourth region correspond to the second external electrode.

26. The liquid crystal display device of claim 19, further comprising:
a diffusing plate disposed over the flat fluorescent lamp to diffuse light emitted from the flat fluorescent lamp; and
an optical sheet disposed over the diffusing plate.

27. The liquid crystal display device of claim 26, further comprising:
a receiving container configured to receive the flat fluorescent lamp;
an insulating member disposed between the flat fluorescent lamp and the receiving container;
a first mold frame fixing the flat fluorescent lamp relative to the receiving container, and supporting the diffusing plate; and
a second mold frame fixing the diffusing plate and the optical sheet relative to the receiving container, and supporting the liquid crystal display panel.

28. The flat fluorescent lamp of claim 19, wherein the first external electrode is formed on the outer surface of the second substrate to cross the discharge spaces.

29. A flat fluorescent lamp comprising:
a first substrate;
a second substrate having a first side, a second side, a third side, and a fourth side, the second substrate combined with the first substrate to define a plurality of discharge spaces extending generally parallel with the third side and the fourth side; and
a first external electrode formed on an outer surface of the second substrate, the first external electrode extending generally parallel to the first side of the second substrate,
a region of the second substrate being located between the first external electrode and the discharge spaces having a varying thickness.

30. The flat fluorescent lamp of claim 29, wherein the thickness of the region is thinner adjacent the third and fourth sides of the second substrate than within a central area of the second substrate.

31. The flat fluorescent lamp of claim 29, further comprising a first area of the region having a thinner thickness than a second area of the region, wherein a discharge space corresponding to the first area of the region has a substantially same luminance as a discharge space corresponding to the second area of the region.

32. The flat fluorescent lamp of claim 29, wherein the first external electrode is formed on the outer surface of the second substrate to cross the discharge spaces.
